(19) United States
(12) Patent Application Publication
(10) Pub. No.: US 2023/0213051 A1
(43) Pub. Date: Jul. 6, 2023

(54) TOLERANCE RING WITH MODIFIED SURFACE PROPERTIES

(71) Applicant: SAINT-GOBAIN PERFORMANCE PLASTICS RENCOL LIMITED, Leicestershire (GB)

(72) Inventors: Alejandro PENA, Bristol (GB); Juergen HARTMANN, Hergatz (DE); Llewelyn PICKERING, Bristol (GB); Thomas CHILDS, Bristol (GB); Thomas FRANCIS, Bristol (GB)

(21) Appl. No.: 18/148,551

(22) Filed: Dec. 30, 2022

Related U.S. Application Data
(60) Provisional application No. 63/266,229, filed on Dec. 30, 2021.

(51) Int. Cl. F16B 7/04; B21D 53/36; B05D 5/02

(52) U.S. Cl. CPC F16B 7/0413; B21D 53/36; B05D 5/02

(57) ABSTRACT

Systems and methods include providing a tolerance ring with a friction enhancement feature on at least one surface of the tolerance ring to increase at least one friction-related property of the tolerance ring. The friction enhancement feature provides the tolerance ring with an increased retention force while providing an optimum radial force that allows a component secured by the tolerance ring to move freely while reducing or altogether preventing axial movement of the component.

### CROSS-REFERENCE TO RELATED APPLICATION(S)

This application claims priority under 35 U.S.C. § 119(e) to U.S. Provisional Application No. 63/266,229, entitled “TOLERANCE RING WITH MODIFIED SURFACE PROPERTIES,” by Alejandro PENA et al., filed Dec. 30, 2021, which is assigned to the current assignee hereof and incorporated herein by reference in its entirety.

### BACKGROUND OF THE INVENTION

Tolerance rings are commonly used between hardware components in a wide variety of industries. Some tolerance ring applications require the tolerance ring to retain a component, such as a bearing, within a housing or other hardware component while allowing free movement of the component. However, axial forces required for the proper retention of the component within the housing or other hardware component may impart undesirable axial forces on the component, which may restrict the free movement of the component. Accordingly, the industry continues to demand improvements in tolerance ring technology for such applications.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a cross-sectional view of a tolerance ring according to an embodiment of the disclosure.

FIG. 2A is a cross-sectional view of an assembly according to an embodiment of the disclosure.

FIG. 2B is a top view of an assembly according to an embodiment of the disclosure.

FIG. 3 is a flowchart of a method of forming a tolerance ring according to an embodiment of the disclosure.

The use of the same reference symbols in different drawings indicates similar or identical items.

### DETAILED DESCRIPTION

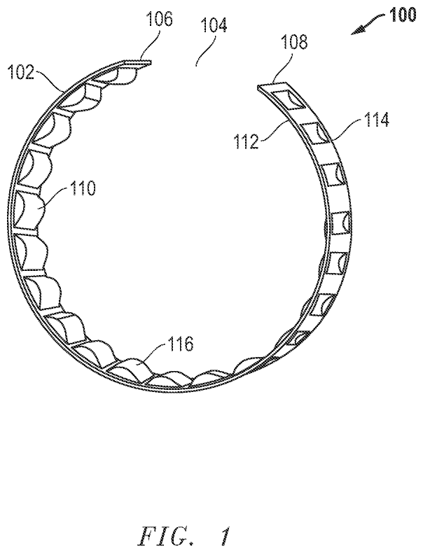

FIG. 1 is a cross-sectional view of a tolerance ring 100 according to an embodiment of the disclosure. The tolerance ring 100 may generally comprise a band of material or a substrate 102 formed into an annular ring shape. In some embodiments, the tolerance ring 100 may comprise a gap 104 defining a first circumferential end 106 and a second circumferential end 108 of the substrate 102. In some embodiments, the substrate 102 may be formed from a resilient metallic material. In some embodiments, the metallic material may comprise aluminum, beryllium, bronze, copper, iron, magnesium, steel, spring steel, stainless steel, tin, titanium, tungsten, or an alloy thereof.

The tolerance ring 100 may comprise a plurality of protrusions 110 (e.g., fingers, waves, etc.) formed in the substrate 102. In some embodiments, the protrusions 110 may protrude radially inward from an inner surface 112 or radially outward from an outer surface 114 of the substrate 100. In some embodiments, the protrusions 110 may be disposed circumferentially about the substrate 102. In some embodiments, the protrusions 110 may comprise the same geometric shape and/or size as compared to each other. In other embodiments, a number of protrusions 110 may have different geometric shapes and/or sizes as compared to each other. In yet other embodiments, all of the protrusions 110 may have different geometric shapes and/or sizes as compared to each other. It will be appreciated that the protrusions 100 may be selected to provide desired elastic/plastic deformation characteristics, desired force transfer properties, and/or to account for manufacturing tolerances of hardware components, and/or to compensate for thermal expansion and wear that may occur between hardware components during operation.

The tolerance ring 100 may also comprise a friction enhancement feature 116. In some embodiments, the friction enhancement feature 116 may be applied to the inner surface 112 and/or the outer surface 114 of the substrate 102. In some embodiments, the friction enhancement feature 116 may comprise a coating. In some embodiments, the coating may comprise a polymer coating, such as an elastomer-based polymer, a resin-based polymer, rubber, or a combination thereof. In some embodiments, the coating may comprise a ceramic coating. In some embodiments, the coating may comprise a metal, such as a metal powder-filled resin coating. In some embodiments, the coating may comprise an adhesive, such as a methacrylate-based adhesive. In some embodiments, the coating may comprise a single layer. In other embodiments, the coating may comprise a plurality of layers. In such embodiments, the plurality of layers may comprise a first retention layer and a second friction enhancing layer.

In some embodiments, the coating may be applied to the inner surface 112 of the substrate 102, the outer surface 114 of the substrate 102, or a combination thereof. Further, in some embodiments, the coating may be applied over the protrusions 110. In some embodiments, the coating may comprise a thickness of at least 0.001 mm (1 micron), at least 0.01 mm (10 microns), at least 0.02 mm (20 microns), at least 0.03 mm (30 microns), at least 0.04 mm (40 microns), or at least 0.05 mm (50 microns). In some embodiments, the coating may comprise a thickness of not greater than 0.50 mm (500 microns), not greater than 0.25 mm (250 microns), not greater than 0.20 mm (200 microns), not greater than 0.15 mm (150 microns), or not greater than 0.10 mm (100 microns). Further, it will be appreciated that the coating may comprise a thickness between any of these minimum and maximum values, such as at least 0.01 mm (10 microns) to not greater than 0.50 mm (500 microns).

In some embodiments, the friction enhancement feature 116 may comprise a cladding. In some embodiments, the cladding may comprise aluminum, brass, bronze, copper, magnesium, zinc, an alloy thereof, an oxide-free corrosion-resistant metallic material, or any combination thereof. In some embodiments, the cladding may comprise a single layer. In other embodiments, the cladding may comprise a plurality of layers. In such embodiments, the plurality of layers may comprise a first retention layer and a second friction enhancing layer. In some embodiments, the cladding may be applied to the inner surface 112 of the substrate 102, the outer surface 114 of the substrate 102, or a combination thereof. Further, in some embodiments, the cladding may be applied over the protrusions 110.

In some embodiments, the cladding may comprise a thickness of at least 0.01 mm (10 microns), at least 0.02 mm (20 microns), at least 0.03 mm (30 microns), at least 0.04 mm (40 microns), or at least 0.05 mm (50 microns). In some embodiments, the cladding may comprise a thickness of not greater than 0.50 mm (500 microns), not greater than 0.25 mm (250 microns), not greater than 0.20 mm (200 microns), not greater than 0.15 mm (150 microns), or not greater than 0.10 mm (100 microns). Further, it will be appreciated that the cladding may comprise a thickness between any of these minimum and maximum values, such as at least 0.01 mm (10 microns) to not greater than 0.50 mm (500 microns).

In some embodiments, the friction enhancement feature 116 may comprise a surface treatment. In some embodiments, the surface treatment may comprise a mechanical surface treatment, such as shot peening, sand blasting, or a combination thereof. In some embodiments, the surface treatment may be applied to the inner surface 112 of the substrate 102, the outer surface 114 of the substrate 102, or a combination thereof. Further, in some embodiments, the surface treatment may be applied over the protrusions 110. In some embodiments, the surface treatment may be applied over at least 5%, at least 10%, at least 25%, at least 50%, at least 75%, at least 80%, at least 85%, or at least 90% of the substrate 102. In some embodiments, the surface treatment may be applied over not greater than 95%, not greater than 90%, not greater than 85%, not greater than 80%, not greater than 75%, or not greater than 50% of the substrate 102. Further, it will be appreciated that the surface treatment may be applied over the substrate 102 between any of these minimum and maximum values, such as at least 5% to not greater than 95% of the substrate 102.

In some embodiments, the friction enhancement feature 116 may be configured to increase at least one performance property of the tolerance ring 100. In some embodiments, the friction enhancement feature 116 may be configured to increase at least one friction-related property of the tolerance ring 100. In some embodiments, the friction enhancement feature 116 may be configured to increase a coefficient of friction of the tolerance ring 100. In some embodiments, the friction enhancement feature 116 may be configured to increase the coefficient of friction of the tolerance ring 100 by at least 1%, at least 2%, at least 3%, at least 4%, at least 5%, at least 10%, at least 15%, at least 20%, at least 25%, at least 30%, at least 35%, at least 40%, or at least 50%. In some embodiments, the friction enhancement feature 116 may be configured to increase the coefficient of friction of the tolerance ring 100 by not greater than 1000%, not greater than 500%, not greater than 200%, not greater than 100%, not greater than 75%, or not greater than 50%. Further, it will be appreciated that the friction enhancement feature 116 may be configured to increase the coefficient of friction of the tolerance ring 100 between any of these minimum and maximum values, such as at least 1% to not greater than 500%.

In some embodiments, the friction enhancement feature 116 may be configured to provide the tolerance ring 100 with a coefficient of friction of at least 0.15, at least 0.20, at least 0.25, at least 0.3, at least 0.35, at least 0.40, at least 0.45, at least 0.50, at least 0.55, or at least 0.60. In some embodiments, the friction enhancement feature 116 may be configured to provide the tolerance ring 100 with a coefficient of friction of not greater than 0.95, not greater than 0.90, not greater than 0.85, not greater than 0.80, not greater than 0.75, not greater than 0.70, not greater than 0.65, not greater than 0.60, not greater than 0.55, not greater than 0.50, not greater than 0.45, or not greater than 0.40. Further, it will be appreciated that the friction enhancement feature 116 may be configured to provide the tolerance ring 100 with a coefficient of friction between any of these minimum and maximum values, such as at least 0.15 to not greater than 0.95. In the above-referenced embodiments, it will be further appreciated that the coefficient of friction of the tolerance ring 10 may be measured against aluminum, steel, or stainless steel.

In some embodiments, the friction enhancement feature 116 may be configured to increase a retention force of the tolerance ring 100. In some embodiments, the friction enhancement feature 116 may be configured to increase the retention force of the tolerance ring 100 by at least 1%, at least 2%, at least 3%, at least 4%, at least 5%, at least 10%, at least 15%, at least 20%, at least 25%, at least 30%, at least 35%, at least 40%, or at least 50% for a given assembly force. In some embodiments, the friction enhancement feature 116 may be configured to increase the retention force of the tolerance ring by not greater than 500%, not greater than 200%, not greater than 100%, not greater than 75%, or not greater than 50% for a given assembly force. Further, it will be appreciated that the friction enhancement feature 116 may be configured to increase the retention force of the tolerance ring 100 between any of these minimum and maximum values, such as at least 1% to not greater than 500%.

In some embodiments, the friction enhancement feature 116 may be configured to provide the tolerance ring 100 with a retention force of at least 150 N, at least 250 N, at least 500 N, at least 1000 N, at least 1500 N, at least 2000 N, at least 2250 N, at least 2300 N, at least 2350 N, at least 2400 N, at least 2450 N, at least 2500 N, at least 2550 N, at least 2600 N, at least 2650 N, at least 2700 N, at least 2750 N, at least 2800 N, at least 2850 N, at least 2900 N, at least 2950 N, at least 3000 N, at least 3050 N, at least 3100 N, at least 3150 N, at least 3200 N, at least 3250 N, at least 3300 N, at least 3350 N, at least 3400 N, at least 3450 N, or at least 3500 N. In some embodiments, the friction enhancement feature 116 may be configured to provide the tolerance ring 100 with a retention force of not greater than 6000 N, not greater than 5750 N, not greater than 5500 N, not greater than 5250 N, not greater than 5000 N, not greater than 4750 N, not greater than 4500 N, not greater than 4250 N, not greater than 4000 N, not greater than 3750 N, not greater than 3500 N, not greater than 3250 N, not greater than 3000 N, not greater than 2950 N, not greater than 2900 N, not greater than 2850 N, not greater than 2800 N, not greater than 2750 N, not greater than 2700 N, not greater than 2650 N, not greater than 2600 N, not greater than 2550 N, or not greater than 2500 N. Further, it will be appreciated that the friction enhancement feature 116 may be configured to provide the tolerance ring 100 with a retention force between any of these minimum and maximum values, such as at least 2250 N to not greater than 6000 N.

In some embodiments, the friction enhancement feature 116 may be configured to increase a surface roughness (Ra, Rz) of the tolerance ring 100. In some embodiments, the friction enhancement feature 116 may be configured to increase the surface roughness of the tolerance ring 100 by at least 1%, at least 2%, at least 3%, at least 4%, at least 5%, at least 10%, at least 15%, at least 20%, at least 25%, at least 30%, at least 35%, at least 40%, or at least 50%. In some embodiments, the friction enhancement feature 116 may be configured to increase the surface roughness of the tolerance ring 100 by not greater than 500%, not greater than 200%, not greater than 100%, not greater than 75%, or not greater than 50%. Further, it will be appreciated that the friction enhancement feature 116 may be configured to increase the surface roughness of the tolerance ring 100 between any of these minimum and maximum values, such as at least 1% to not greater than 500%.

In some embodiments, the friction enhancement feature 116 may be configured to provide the tolerance ring 100 with a surface roughness (Ra) of at least 1.5, at least 2, at least 2.5, at least 3.0, at least 3.5, at least 4.0, at least 5.0, at least 5.5, or at least 6.0. In some embodiments, the friction enhancement feature 116 may be configured to provide the tolerance ring 100 with a surface roughness (Ra) of not greater than 25, not greater than 20, not greater than 19, not greater than 18, not greater than 17, not greater than 16, not greater than 15, not greater than 14, not greater than 13, not greater than 12, not greater than 11, not greater than 10, or not greater than 5. Further, it will be appreciated that the friction enhancement feature 116 may be configured to provide the tolerance ring 100 with a surface roughness (Ra) between any of these minimum and maximum values, such as at least 1.5 to not greater than 25.

In some embodiments, the friction enhancement feature 116 may be configured to provide the tolerance ring 100 with a surface roughness (Rz) of at least 5, at least 6, at least 7, at least 8, at least 9, at least 10, at least 11, at least 12, at least 13, at least 14, at least 15, at least 20, or at least 25. In some embodiments, the friction enhancement feature 116 may be configured to provide the tolerance ring 100 with a surface roughness (Rz) of not greater than 50, not greater than 35, not greater than 30, not greater than 25, not greater than 20, not greater than 19, not greater than 18, not greater than 17, not greater than 16, or not greater than 15. Further, it will be appreciated that the friction enhancement feature 116 may be configured to provide the tolerance ring 100 with a surface roughness (Rz) between any of these minimum and maximum values, such as at least 5 to not greater than 50.

In some embodiments, the friction enhancement feature 116 may be configured to provide the tolerance ring 100 with a Retention to Assembly Ratio (RAR) defined by the equation:

Retention to Assembly Ratio(RAR)=Retention Force/Peak Assembly Force

In some embodiments, disassembly retention force may be used instead of peak assembly force. In some embodiments, the friction enhancement feature 116 may be configured to provide the tolerance ring 100 with a Retention to Assembly Ratio (RAR) of at least 0.5, at least 0.51, at least 0.52, at least 0.53, at least 0.54, at least 0.55, at least 0.56, at least 0.57, at least 0.58, at least 0.59, at least 0.60, at least 0.65, at least 0.70, at least 0.75, at least 0.80, or at least 0.85. In some embodiments, the friction enhancement feature 116 may be configured to provide the tolerance ring 100 with a Retention to Assembly Ratio (RAR) of not greater than 5, not greater than 4, not greater than 3, not greater than 2, not greater than 1, not greater than 0.90, not greater than 0.89, not greater than 0.88, not greater than 0.87, not greater than 0.86, not greater than 0.85, not greater than 0.80, not greater than 0.75, not greater than 0.70, or not greater than 0.65. Further, it will be appreciated that the friction enhancement feature 116 may be configured to provide the tolerance ring 100 with a Retention to Assembly Ratio (RAR) between any of these minimum and maximum values, such as at least 0.5 to not greater than 0.90.

In some embodiments, the retention force of the tolerance ring 100 may have a variance based on temperature. In some embodiments, the retention force of the tolerance ring 100 have a variance of at least 1%, at least 2%, at least 3%, at least 4%, at least 5%, at least 6%, at least 7%, at least 8%, at least 9%, at least 10%, at least 15%, at least 20%, or at least 25% higher or lower based on the temperature range of between −40° C. and 200° C., such as between −20° C. and 150° C., such as between −10° C. and 120° C., such as between 0° C. and 100° C., or such as between 25° C. and 75° C. Further, it will be appreciated that the retention force of the tolerance ring 100 may be between any of these minimum and maximum values, such as at least 1% to not greater than 100%.

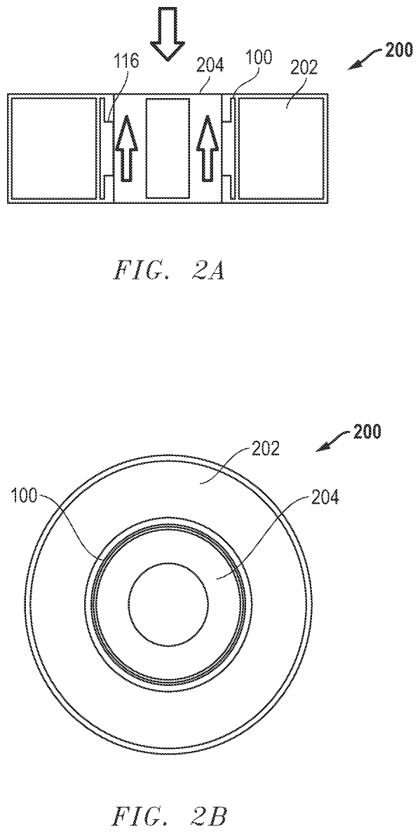

FIG. 2A shows a cross-sectional view of an assembly 200 comprising a tolerance ring 100 according to an embodiment of the disclosure. FIG. 2B shows a top view of an assembly 200 comprising a tolerance ring 100 according to an embodiment of the disclosure. The assembly 100 may generally comprise an outer component 202 and an inner component 204. In some embodiments, the outer component 202 may comprise a housing. In some embodiments, the outer component 202 may be formed from aluminum, steel, stainless steel, or titanium. In some embodiments, the inner component 204 may be a component, such as a bearing. In some embodiments, the inner component 204 may be formed from aluminum, steel, stainless steel, or titanium. The tolerance ring 100 may generally be disposed within the outer component 202 and configured to retain or secure the inner component 204 within the outer component 202.

Furthermore, as described herein, the tolerance ring 100 may comprise a friction enhancement feature 116 that increases a coefficient of friction between the tolerance ring 100 and the outer component 202 and/or the inner component 204, increases a peak assembly force to install and/or remove the tolerance ring 100 from the outer component 202, increases a retention force applied by the tolerance ring 100 on the inner component 204 to retain or secure the inner component 204 within the outer component 202, and/or increases a surface roughness (Ra, Rz) of the tolerance ring 100. The increase in the aforementioned values may be compared to a traditional tolerance ring that does not include a friction enhancement feature 116. Further, in some embodiments, the friction enhancement feature 116 may provide the tolerance ring 100 with an increased retention force while providing an optimum radial force that allows the inner component 204 secured by the tolerance ring 100 to move freely while reducing or altogether preventing axial movement of the inner component 204.

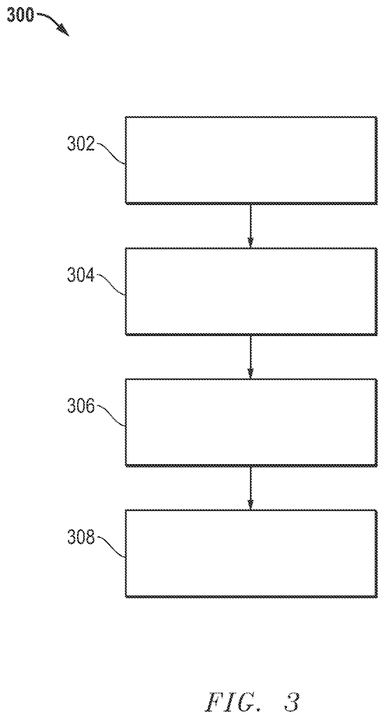

FIG. 3 is a flowchart of a method 300 of forming a tolerance ring 100 according to an embodiment of the disclosure. The method 300 may begin at block 302 by providing a substantially flat substrate 102 formed from a metallic material. The method 300 may continue at block 304 by applying a friction enhancement feature 116 to at least one of an inner surface 112 and an outer surface 114 of the substrate 102. The method 300 may continue at block 306 by forming a plurality of protrusions 110 in the substrate 102 that protrude radially inward from the inner surface 112 of the substrate 102 or radially outward from the outer surface 114 of the substrate 102. In some embodiments, it will be appreciated that the method 300 may include forming the plurality of protrusions 110 at block 306 prior to applying the friction enhancement feature 116 to the substrate 102 at block 304. The method may continue at block 308 by forming the substrate 102 into an annular ring-shaped tolerance ring 100.

### Examples

A standard tolerance ring, C1, and two exemplary embodiments, S1 and S2, of a tolerance ring 100 were created. Each of C1, S1, and S2 were created from a stainless steel substrate 102 and included a plurality of protrusions 116 formed in the substrate 102. C1 did not include any friction enhancement features 116. S1 included a friction enhancement feature 116 comprising at least one aluminum outer layer overlying the inner diameter and the outer diameter of the substrate 102. S2 included a friction enhancement feature 116 comprising a high temperature coating based on a modified polyester resin, such as Thermodur 600, disposed over the substrate 102. C1, S1, and S2 were placed in identical aluminum housings, and a bearing was installed in each of the assemblies. The maximum assembly force and the remaining assembly force were measured during assembly. Table 1 shows the maximum assembly force and the remaining assembly force for a 0.905 mm clearance (ID 23.810 mm). Table 2 shows the maximum assembly force and the remaining assembly force for a 0.9705 mm clearance (ID 23.941 mm).

TABLE 1

| Specimen | Maximum | Remaining |
|---|---|---|
| (0.905 mm | Assembly | Assembly |
| Clearance) | Force (N) | Force (N) |
| C1 | 2915 | 2778 |
| S1 | 4172 | 3517 |
| S2 | 4450 | 3385 |

TABLE 2

| Specimen | Maximum | Remaining |
|---|---|---|
| (0.9705 mm | Assembly | Assembly |
| Clearance) | Force (N) | Force (N) |
| C1 | 2226 | 2148 |
| S1 | 1433 | 1115 |
| S2 | 1795 | 1569 |

Additional samples were created of each of C1, S1, and S2. Table 3 shows the average assembled torque, remaining assembly force, retention force, and Retention to Assembly Ratio (RAR) for the total number of samples.

TABLE 3

| | Assembled Avg. | Remaining Assembly | Retention | RAR |
|---|---|---|---|---|
| Specimen | Torque (g-cm) | Force (N) | Force (N) | (%) |
| C1 | 72 | 2731 | 2388 | 87 |
| S1 | 35 | 3833 | 2291 | 60 |
| S2 | 89 | 3339 | 2564 | 77 |

Additional samples were created of each of C1, S1, and S2. The samples were tested at heated and non-heated conditions. Table 4 shows a comparison of the retention force when non-heated and when heated for the total number of samples. Notably, the retention force of C1 decreased when heated, while the retention force of S1 and S2 increased when heated.

TABLE 4

| | Retention Force | Retention Force | Difference |
|---|---|---|---|
| Specimen | (Non-heated) (N) | (Heated) (N) | (%) |
| C1 | 2388 | 1973 | −17 |
| S1 | 2291 | 2425 | 6 |
| S2 | 2564 | 2739 | 7 |

Embodiments of a tolerance ring 100, an assembly 200, and/or a method 300 of forming a tolerance ring 100 may include one or more of the following:

Embodiment 1: A tolerance ring, comprising: an annular ring-shaped substrate formed from a metallic material and comprising a plurality of protrusions protruding radially inward from an inner surface of the substrate or radially outward from an outer surface of the substrate; and a friction enhancement feature applied to at least one of the inner surface and the outer surface of the substrate.

Embodiment 2: The tolerance ring of embodiment 1, wherein the metallic material of the substrate comprises steel, spring steel, or stainless steel.

Embodiment 3: The tolerance ring of any one of embodiments 1 to 2, wherein the friction enhancement feature comprises a coating, a cladding, a surface treatment, or a combination thereof.

Embodiment 4: The tolerance ring of embodiment 3, wherein the coating comprises a polymer coating.

Embodiment 5: The tolerance ring of embodiment 4, wherein the polymer coating comprises an elastomer-based polymer, a resin-based polymer, rubber, or a combination thereof.

Embodiment 6: The tolerance ring of embodiment 3, wherein the coating comprises a ceramic coating.

Embodiment 7: The tolerance ring of embodiment 3, wherein the coating comprises a metal.

Embodiment 8: The tolerance ring of embodiment 7, wherein the metal comprises a metal powder-filled resin coating.

Embodiment 9: The tolerance ring of embodiment 3, wherein the coating comprises an adhesive.

Embodiment 10: The tolerance ring of embodiment 9, wherein the adhesive comprises a methacrylate-based adhesive.

Embodiment 11: The tolerance ring of any one of embodiments 3 to 10, wherein the coating comprises a plurality of layers.

Embodiment 12: The tolerance ring of embodiment 11, wherein the plurality of layers comprises a first retention layer and a second friction enhancing layer.

Embodiment 13: The tolerance ring of any one of embodiments 3 to 12, wherein the coating is applied to the inner surface of the substrate, the outer surface of the substrate, or a combination thereof.

Embodiment 14: The tolerance ring of embodiment 13, wherein the coating is applied over the protrusions.

Embodiment 15: The tolerance ring of any one of embodiments 3 to 14, wherein the coating comprises a thickness of at least 0.001 mm (1 micron), at least 0.01 mm (10 microns), at least 0.02 mm (20 microns), at least 0.03 mm (30 microns), at least 0.04 mm (40 microns), or at least 0.05 mm (50 microns).

Embodiment 16: The tolerance ring of embodiment 15, wherein the coating comprises a thickness of not greater than 0.50 mm (500 microns), not greater than 0.25 mm (250 microns), not greater than 0.20 mm (200 microns), not greater than 0.15 mm (150 microns), or not greater than 0.10 mm (100 microns).

Embodiment 17: The tolerance ring of embodiment 3, wherein the cladding comprises aluminum, brass, bronze, copper, magnesium, zinc, an alloy thereof, an oxide-free corrosion-resistant metallic material, or any combination thereof.

Embodiment 18: The tolerance ring of any one of embodiments 3 and 17, wherein the cladding comprises a plurality of layers.

Embodiment 19: The tolerance ring of embodiment 18, wherein the plurality of layers comprises a first retention layer and a second friction enhancing layer.

Embodiment 20: The tolerance ring of any one of embodiments 3 and 17 to 19, wherein the cladding is applied to the inner surface of the substrate, the outer surface of the substrate, or a combination thereof.

Embodiment 21: The tolerance ring of embodiment 20, wherein the cladding is applied over the protrusions.

Embodiment 22: The tolerance ring of any one of embodiments 3 and 17 to 21, wherein the cladding comprises a thickness of at least 0.01 mm (10 microns), at least 0.02 mm (20 microns), at least 0.03 mm (30 microns), at least 0.04 mm (40 microns), or at least 0.05 mm (50 microns).

Embodiment 23: The tolerance ring of embodiment 22, wherein the cladding comprises a thickness of not greater than 0.50 mm (500 microns), not greater than 0.25 mm (250 microns), not greater than 0.20 mm (200 microns), not greater than 0.15 mm (150 microns), or not greater than 0.10 mm (100 microns).

Embodiment 24: The tolerance ring of embodiment 3, wherein the surface treatment comprises a mechanical surface treatment.

Embodiment 25: The tolerance ring of embodiment 24, wherein the mechanical surface treatment comprises shot peening, sand blasting, or a combination thereof.

Embodiment 26: The tolerance ring of any one of embodiments 3 and 24 to 25, wherein the surface treatment is applied to the inner surface of the substrate, the outer surface of the substrate, or a combination thereof.

Embodiment 27: The tolerance ring of embodiment 26, wherein the surface treatment is applied over the protrusions.

Embodiment 28: The tolerance ring of any one of embodiments 1 to 27, wherein the friction enhancement feature is configured to increase at least one performance property of the tolerance ring.

Embodiment 29: The tolerance ring of any one of embodiments 1 to 28, wherein the friction enhancement feature is configured to increase at least one friction-related property of the tolerance ring.

Embodiment 30: The tolerance ring of embodiment 29, wherein the friction enhancement feature is configured to increase a coefficient of friction of the tolerance ring.

Embodiment 31: The tolerance ring of embodiment 30, wherein the friction enhancement feature is configured to increase a coefficient of friction of the tolerance ring by at least 1%, at least 2%, at least 3%, at least 4%, at least 5%, at least 10%, at least 15%, at least 20%, at least 25%, at least 30%, at least 35%, at least 40%, or at least 50%.

Embodiment 32: The tolerance ring of embodiment 31, wherein the friction enhancement feature is configured to increase a coefficient of friction of the tolerance ring by not greater than 1000%, not greater than 500%, not greater than 200%, not greater than 100%, not greater than 75%, or not greater than 50%.

Embodiment 33: The tolerance ring of any one of embodiments 29 to 32, wherein the friction enhancement feature is configured to provide the tolerance ring with a coefficient of friction of at least 0.15, at least 0.20, at least 0.25, at least 0.3, at least 0.35, at least 0.40, at least 0.45, at least 0.50, at least 0.55, or at least 0.60.

Embodiment 34: The tolerance ring of embodiment 33, wherein the friction enhancement feature is configured to provide the tolerance ring with a coefficient of friction of not greater than 0.95, not greater than 0.90, not greater than 0.85, not greater than 0.80, not greater than 0.75, not greater than 0.70, not greater than 0.65, not greater than 0.60, not greater than 0.55, not greater than 0.50, not greater than 0.45, or not greater than 0.40.

Embodiment 35: The tolerance ring of any one of embodiments 33 to 34, wherein the coefficient of friction of the tolerance ring is measured against aluminum, steel, or stainless steel.

Embodiment 36: The tolerance ring of any one of embodiments 29 to 35, wherein the friction enhancement feature is configured to increase a retention force of the tolerance ring.

Embodiment 37: The tolerance ring of embodiment 36, wherein the friction enhancement feature is configured to increase a retention force of the tolerance ring by at least 1%, at least 2%, at least 3%, at least 4%, at least 5%, at least 10%, at least 15%, at least 20%, at least 25%, at least 30%, at least 35%, at least 40%, or at least 50% for a given assembly force.

Embodiment 38: The tolerance ring of embodiment 37, wherein the friction enhancement feature is configured to increase a retention force of the tolerance ring by not greater than 500%, not greater than 200%, not greater than 100%, not greater than 75%, or not greater than 50% for a given assembly force.

Embodiment 39: The tolerance ring of any one of embodiments 29 to 38, wherein the friction enhancement feature is configured to provide the tolerance ring with a retention force of at least 150 N, at least 250 N, at least 500 N, at least 1000 N, at least 1500 N, at least 2000 N, at least 2250 N, at least 2500 N, at least 2600 N, at least 2650 N, at least 2700 N, at least 2750 N, at least 2800 N, at least 2850 N, at least 2900 N, at least 2950 N, at least 3000 N, at least 3050 N, at least 3100 N, at least 3150 N, at least 3200 N, at least 3250 N, at least 3300 N, at least 3350 N, at least 3400 N, at least 3450 N, or at least 3500 N.

Embodiment 40: The tolerance ring of embodiment 39, wherein the friction enhancement feature is configured to provide the tolerance ring with a retention force of not greater than 6000 N, not greater than 5750 N, not greater than 5500 N, not greater than 5250 N, not greater than 5000 N, not greater than 4750 N, not greater than 4500 N, not greater than 4250 N, not greater than 4000 N, not greater than 3750 N, not greater than 3500 N, not greater than 3250 N, not greater than 3000 N, not greater than 2950 N, not greater than 2900 N, not greater than 2850 N, not greater than 2800 N, not greater than 2750 N, not greater than 2700 N, not greater than 2650 N, not greater than 2600 N, not greater than 2550 N, or not greater than 2500 N.

Embodiment 41: The tolerance ring of any one of embodiments 29 to 40, wherein the friction enhancement feature is configured to increase a surface roughness of the tolerance ring.

Embodiment 42: The tolerance ring of embodiment 41, wherein the friction enhancement feature is configured to increase a surface roughness of the tolerance ring by at least 1%, at least 2%, at least 3%, at least 4%, at least 5%, at least 10%, at least 15%, at least 20%, at least 25%, at least 30%, at least 35%, at least 40%, or at least 50%.

Embodiment 43: The tolerance ring of embodiment 42, wherein the friction enhancement feature is configured to increase a surface roughness of the tolerance ring by not greater than 500%, not greater than 200%, not greater than 100%, not greater than 75%, or not greater than 50%.

Embodiment 44: The tolerance ring of any one of embodiments 29 to 43, wherein the friction enhancement feature is configured to provide the tolerance ring with a surface roughness (Ra) of at least 1.5, at least 2, at least 2.5, at least 3.0, at least 3.5, at least 4.0, at least 5.0, at least 5.5, or at least 6.0.

Embodiment 45: The tolerance ring of embodiment 44, wherein the friction enhancement feature is configured to provide the tolerance ring with a surface roughness (Ra) of not greater than 25, not greater than 20, not greater than 19, not greater than 18, not greater than 17, not greater than 16, not greater than 15, not greater than 14, not greater than 13, not greater than 12, not greater than 11, not greater than 10, or not greater than 5.

Embodiment 46: The tolerance ring of any one of embodiments 29 to 45, wherein the friction enhancement feature is configured to provide the tolerance ring with a surface roughness (Rz) of at least 5, at least 6, at least 7, at least 8, at least 9, at least 10, at least 11, at least 12, at least 13, at least 14, at least 15, at least 20, or at least 25.

Embodiment 47: The tolerance ring of embodiment 46, wherein the friction enhancement feature is configured to provide the tolerance ring with a surface roughness (Rz) of not greater than 50, not greater than 35, not greater than 30, not greater than 25, not greater than 20, not greater than 19, not greater than 18, not greater than 17, not greater than 16, or not greater than 15.

Embodiment 48: The tolerance ring of any one of embodiments 1 to 47, wherein the tolerance ring comprises a Retention to Assembly Ratio (RAR) of at least 0.5, at least 0.51, at least 0.52, at least 0.53, at least 0.54, at least 0.55, at least 0.56, at least 0.57, at least 0.58, at least 0.59, at least 0.60, at least 0.65, at least 0.70, at least 0.75, at least 0.80, or at least 0.85.

Embodiment 49: The tolerance ring of any one of embodiments 1 to 47, wherein the tolerance ring comprises a Retention to Assembly Ratio (RAR) of not greater than 5, not greater than 4, not greater than 3, not greater than 2, not greater than 1, not greater than 0.90, not greater than 0.89, not greater than 0.88, not greater than 0.87, not greater than 0.86, not greater than 0.85, not greater than 0.80, not greater than 0.75, not greater than 0.70, or not greater than 0.65.

Embodiment 50: The tolerance ring of any one of embodiments 1 to 49, wherein the retention force of the tolerance ring has a variance of +/−5% between a temperature range of −40° C. to 200° C.

Embodiment 51: The tolerance ring of any one of embodiments 1 to 49, wherein the retention force of the tolerance ring has a variance of +/−10% between a temperature range of −40° C. to 200° C.

Embodiment 52: The tolerance ring of embodiment 51, wherein the retention force of the tolerance ring has a variance of +/−15% between a temperature range of −40° C. to 200° C.

Embodiment 53: The tolerance ring of any one of embodiments 51 to 52, wherein the retention force of the tolerance ring has a variance of +/−25% between a temperature range of −40° C. to 200° C.

Embodiment 54: An assembly, comprising: an outer component comprising a housing; an inner component comprising a component; and a tolerance ring according to any of the preceding embodiments, wherein the tolerance ring is disposed within the housing and configured to retain or secure the component within the housing.

Embodiment 55: The assembly of embodiment 54, wherein the housing is formed from aluminum, steel, stainless steel, or titanium.

Embodiment 56: The assembly of any one of embodiments 54 to 55, wherein the component is formed from aluminum, steel, stainless steel, or titanium.

Embodiment 57: The assembly of embodiment 54, wherein the component comprises a bearing.

Embodiment 58: A method of forming a tolerance ring according to any of the preceding embodiments, comprising: providing a substantially flat substrate formed from a metallic material; applying a friction enhancement feature to at least one of an inner surface and an outer surface of the substrate; forming a plurality of protrusions in the substrate that protrude radially inward from the inner surface of the substrate or radially outward from the outer surface of the substrate; and forming the substrate into an annular ring-shaped tolerance ring.

Note that not all of the activities described above in the general description or the examples are required, that a portion of a specific activity may not be required, and that one or more further activities may be performed in addition to those described. Still further, the order in which activities are listed is not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A tolerance ring, comprising:
an annular ring-shaped substrate formed from a metallic material and comprising a plurality of protrusions protruding radially inward from an inner surface of the substrate or radially outward from an outer surface of the substrate; and
a friction enhancement feature applied to at least one of the inner surface and the outer surface of the substrate.

2. The tolerance ring of claim 1, wherein the metallic material of the substrate comprises steel, spring steel, or stainless steel.

3. The tolerance ring of claim 1, wherein the friction enhancement feature comprises a coating, a cladding, a surface treatment, or a combination thereof.

4. The tolerance ring of claim 3, wherein the coating comprises a polymer coating.

5. The tolerance ring of claim 4, wherein the polymer coating comprises an elastomer-based polymer, a resin-based polymer, rubber, or a combination thereof.

6. The tolerance ring of claim 3, wherein the coating comprises a ceramic coating.

7. The tolerance ring of claim 3, wherein the coating comprises a metal.

8. The tolerance ring of claim 7, wherein the metal comprises a metal powder-filled resin coating.

9. The tolerance ring of claim 3, wherein the coating comprises an adhesive.

10. The tolerance ring of claim 9, wherein the adhesive comprises a methacrylate-based adhesive.

11. The tolerance ring of claim 3, wherein the coating comprises a plurality of layers comprising a first retention layer and a second friction enhancing layer.

12. The tolerance ring of claim 3, wherein the cladding comprises aluminum, brass, bronze, copper, magnesium, zinc, an alloy thereof, an oxide-free corrosion-resistant metallic material, or any combination thereof.

13. The tolerance ring of claim 3, wherein the surface treatment comprises a mechanical surface treatment comprising shot peening, sand blasting, or a combination thereof.

14. The tolerance ring of claim 1, wherein the friction enhancement feature is configured to increase a coefficient of friction of the tolerance ring by at least 1% and not greater than 1000%.

15. The tolerance ring of claim 1, wherein the friction enhancement feature is configured to provide the tolerance ring with a coefficient of friction of at least 0.15 and no greater than 0.95.

16. The tolerance ring of claim 1, wherein the friction enhancement feature is configured to increase a retention force of the tolerance ring by at least 1% and no greater than 500%.

17. The tolerance ring of claim 1, wherein the friction enhancement feature is configured to increase a surface roughness of the tolerance ring by at least 1% and no greater than 500%.

18. The tolerance ring of claim 1, wherein the tolerance ring comprises a Retention to Assembly Ratio (RAR) of at least 0.5 and no greater than 5.

19. An assembly, comprising:
an outer component comprising a housing;
an inner component comprising a component; and
a tolerance ring according to claim 1, wherein the tolerance ring is disposed within the housing and configured to retain or secure the component within the housing.

20. A method of forming a tolerance ring according to claim 1, comprising:
providing a substantially flat substrate formed from a metallic material;
applying a friction enhancement feature to at least one of an inner surface and an outer surface of the substrate;
forming a plurality of protrusions in the substrate that protrude radially inward from the inner surface of the substrate or radially outward from the outer surface of the substrate; and
forming the substrate into an annular ring-shaped tolerance ring.
